(19) United States
(12) Patent Application Publication
(10) Pub. No.: US 2025/0222381 A1
(43) Pub. Date: Jul. 10, 2025

(54) AIR/PARTICLE SEPARATION DEVICE COMPRISING A ROTARY FILTER MADE OF CELLULAR MATERIAL

(71) Applicant: Airbus SAS, BLAGNAC (FR)

(72) Inventor: Fabian BAUER, BLAGNAC (FR)

(21) Appl. No.: 19/009,300

(22) Filed: Jan. 3, 2025

(30) Foreign Application Priority Data
Jan. 9, 2024 (FR) FR2400185

(51) Int. Cl. B01D 46/00

(52) U.S. Cl. CPC B01D 46/0056

(57) ABSTRACT

An air/particle separation device which comprises a container and a rotary filter positioned in the container, between a laden-air inlet and a treated-air outlet, the container is configured to channel air laden with particles through the rotary filter, the rotary filter comprises at least one block of cellular material configured to be passed through by the laden air and to promote the separation of the particles from the laden air and the ejection of the particles from the rotary filter which migrate, by virtue of the centrifugal effect, toward the periphery of the rotary filter.

### CROSS-REFERENCES TO RELATED APPLICATIONS

This application claims the benefit of French Patent Application Number 2400185 filed on Jan. 9, 2024, the entire disclosure of which is incorporated herein by way of reference.

### FIELD OF THE INVENTION

The present application relates to an air/particle separation device comprising a rotary filter made of cellular material.

### BACKGROUND OF THE INVENTION

The air exiting certain equipment has to be treated to remove from it particles such as particles of oil, lubricant or hydrocarbon for example in order for it to be as pure as possible.

According to one embodiment visible in FIG. 1, an air/particle separation device of the cyclone type comprises a tank 10 having a laden-air inlet 12, a treated-air outlet 14 and a particle outlet 16.

The tank 10 comprises a cylindrical lateral wall 10.1, and lower and upper walls 10.2, 10.3 closing the cylindrical lateral wall 10.1. According to one configuration, the tank 10 comprises at least one cylindrical inner partition 10.4 that is coaxial with the cylindrical lateral wall 10.1.

The particle outlet 16 is positioned in the lower wall 10.2.

According to one configuration, the laden-air inlet 12 and the treated-air outlet 14 are positioned respectively in the cylindrical lateral wall 10.1 and the upper wall 10.3. The laden-air inlet 12, the treated-air outlet 14 and the inner partition 10.4 are arranged in such a way that the flow of air 18 circulates inside the tank 10 in swirling fashion. This swirling flow of air 18 causes, by centrifugation, the separation of the air and particles present in the air which are projected against the cylindrical lateral wall 10.1 and the inner partition 10.4 and run off to be collected in a lower part of the tank 10.

A cyclone separation device can be attached to an air pipe outside the item of equipment generating this air laden with particles, thus facilitating its installation and its maintenance.

However, such an air/particle separation device of the cyclone type is not suitable for treating significant air flow rates of several hundreds of liters per minute.

### SUMMARY OF THE INVENTION

The present invention aims to remedy all or some of the drawbacks of the prior art.

To this end, a subject of the invention is an air/particle separation device comprising a container and a laden-air inlet, a treated-air outlet and a particle outlet opening out into the container.

According to the invention, the air/particle separation device comprises a rotary filter positioned in the container, between the laden-air inlet and the treated-air outlet, the container being configured to channel air laden with particles through the rotary filter, said rotary filter comprising at least one block of cellular material configured to be passed through by the laden air.

According to the invention, the air/particle separation device comprises an inner partition, positioned in the container, which separates an upstream inner zone situated in the container, between the laden-air inlet and the rotary filter, into a central zone configured to channel the laden air in the direction of the rotary filter and a peripheral zone situated between the inner partition and the lateral wall and configured to collect the particles, the laden-air inlet communicating with the central part, and the particle outlet communicating with the peripheral zone.

The rotation of the rotary filter promotes the separation of the air and particles present in the laden air, the migration of the separated particles toward the periphery of the rotary filter and the ejection thereof from the rotary filter by virtue of a centrifugal effect. This solution makes it possible to treat a greater flow rate of laden air than the air/particle separation devices of the cyclone type in the prior art.

According to another feature, the container comprises at least one cylindrical lateral wall having an axis of revolution oriented in a vertical axial direction, the rotary filter being configured to pivot about an axis of pivoting that is coaxial with the cylindrical lateral wall of the container.

According to another feature, the rotary filter comprises an upstream face oriented toward the laden-air inlet, a downstream face oriented toward the treated-air outlet, and a peripheral face, connecting the upstream and downstream faces, that is substantially coaxial with the axis of pivoting, said peripheral face being oriented toward the lateral wall of the container and having a smaller diameter than the inner diameter of the lateral wall.

According to another feature, the rotary filter comprises a cylindrical inner face oriented toward the axis of pivoting. In addition, the air/particle separation device comprises a drive and a pivot shaft having an axis coincident with the axis of pivoting and connected to the drive, the rotary filter being positioned around the pivot shaft and connected thereto.

According to another feature, the cylindrical inner face has an inner diameter substantially equal to the outer diameter of the pivot shaft.

According to another feature, the pivot shaft is hollow and comprises passage orifices configured to make the cylindrical inner face of the rotary filter, the interior of the pivot shaft and the treated-air outlet communicate.

According to another feature, the air/particle separation device comprises an upstream transverse wall connected to the pivot shaft and a downstream transverse wall connected to the pivot shaft and separated from the upstream transverse wall by a distance substantially equal to or slightly less than a distance separating the upstream and downstream faces of the rotary filter.

According to another feature, each of the upstream and downstream transverse walls comprises a circular peripheral edge, having a diameter substantially equal to or slightly greater than the diameter of the peripheral face of the rotary filter, and at least one opening passing through it.

According to another feature, the air/particle separation device comprises a cylindrical peripheral wall connecting the peripheral edges of the upstream and downstream transverse walls and having a diameter substantially equal to or slightly greater than the diameter of the peripheral face of the rotary filter, the cylindrical peripheral wall comprising at least one opening passing through it, the pivot shaft, the upstream and downstream transverse walls and the cylindrical peripheral wall delimiting an annular housing secured to the pivot shaft and configured to house the rotary filter.

According to another feature, the particle outlet opens out in a lower part of the peripheral zone.

According to another feature, the container comprises at least one cylindrical lateral wall. In addition, the partition is substantially cylindrical, coaxial with the lateral wall and extends between a first end connected to the container and a second end slightly spaced apart from the rotary filter.

According to another feature, the container comprises at least lower and upper parts, the lower part comprising a portion of the lateral wall and a lower transverse wall, the upper part comprising a portion of the lateral wall and an upper transverse wall, the lower and upper parts being configured to cooperate in order to form a closed enclosure when they are assembled.

A further subject of the invention is an installation comprising at least one item of equipment emitting a flow of laden air, at least one pipe in which the flow of laden air exiting the item of equipment circulates, and at least one air/particle separation device according to one of the preceding features, positioned between two portions of the pipe.

### BRIEF DESCRIPTION OF THE DRAWINGS

Other features and advantages will become apparent from the following description of the invention, the description being given solely by way of example, with reference to the attached drawings, in which:

FIG. 1 is a schematic representation of an air/particle separation device, illustrating one embodiment of the prior art,

FIG. 2 is a schematic representation of an air/particle separation device, illustrating one embodiment of the invention, and

FIG. 3 is a perspective cross section of an air/particle separation device, illustrating one embodiment of the invention.

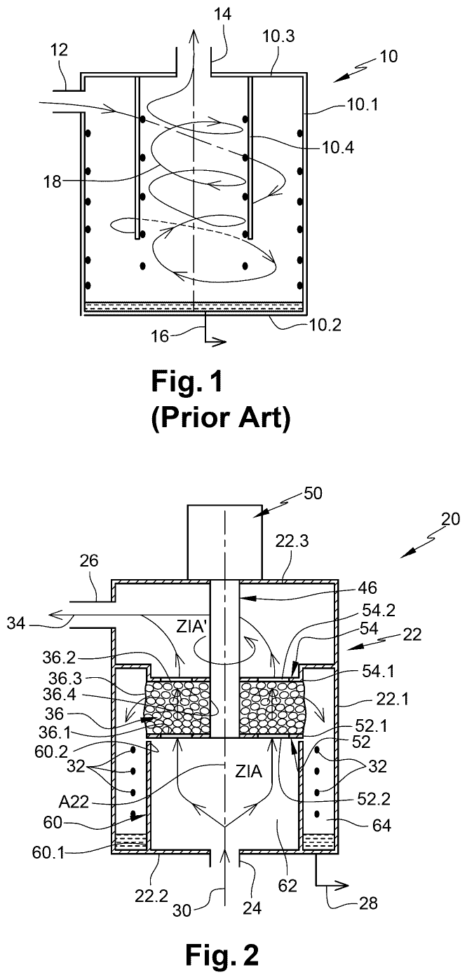

### DETAILED DESCRIPTION OF THE PREFERRED EMBODIMENTS

According to one embodiment, an air/particle separation device 20 comprises a container 22, a laden-air inlet 24 opening out into the container 22, a treated-air outlet 26 which opens out into the container 22, and a particle outlet 28 which opens out into the container 22.

This air/particle separation device 20 is configured to treat laden air 30 containing particles 32 such as particles of oil, lubricant, hydrocarbon or others. These particles 32 contained in the laden air 30 have a greater density than the (non-laden) treated air 34. Generally, these particles 32 are liquid.

According to one application, an installation comprises at least one item of equipment emitting a flow of laden air, at least one pipe in which the flow of laden air exiting the item of equipment circulates, and at least one air/particle separation device 20 positioned, outside the item of equipment, between two portions of the pipe. Since the air/particle separation device 20 is positioned outside the item of equipment generating the air laden with particles, its installation and its maintenance are easier.

The air/particle separation device 20 comprises a rotary filter 36 positioned in the container 22, between the laden-air inlet 24 and the treated-air outlet 26, the container 22 being configured to channel the laden air 30 through the rotary filter 36.

The rotary filter 36 is configured to allow the laden air 30 to pass through it in order to separate the particles 32 from the laden air 30 and allow them to migrate, by a centrifugal effect, at the periphery of the rotary filter 36. According to one embodiment, the rotary filter 36 comprises at least one block of cellular material configured to allow the laden air 30 to pass through it. Cellular material is understood to mean any porous material, such as made of foam, comprising cells. According to one configuration, the rotary filter 36 comprises at least one block of metallic cellular material. By way of example, the cellular material is made of aluminum alloy and is open-celled. Of course, the invention is not limited to these embodiments for the rotary filter 36.

According to one embodiment, the container 22 comprises at least one lateral wall 22.1 having an axis of revolution A22 oriented in an axial direction. In addition, the container 22 comprises lower and upper transverse walls 22.2, 22.3 delimiting, with the lateral wall 22.1, an inner zone of the container 22. According to one arrangement, the axial direction is substantially vertical.

In the inner zone of the container 22, the flow of laden air 30 moves from upstream to downstream, between the laden-air inlet 24 and the treated-air outlet 26. The rotary filter 36 separates the inner zone into an upstream inner zone ZIA situated between the rotary filter 36 and the laden-air inlet 24 and a downstream inner zone ZIA' situated between the rotary filter 36 and the treated-air outlet 26.

According to one embodiment visible in FIG. 3, the container 22 is made of at least two parts and comprises a lower part 40 comprising a portion of the lateral wall 22.1 and the lower transverse wall 22.2, and an upper part 42 comprising a portion of the lateral wall 22.1 and the upper transverse wall 22.3, the lower and upper parts 40, 42 being configured to cooperate in order to form a closed enclosure when they are assembled. According to one configuration, the lower part 40 comprises a first cylindrical wall 40.1 having an inner diameter D40.1. The upper part 42 comprises a second cylindrical wall 42.1, a third cylindrical wall 42.2 having an outer diameter D42.2 substantially (i.e., +/−10%) equal to the inner diameter D40.1 of the first cylindrical wall 40.1, and a transverse wall 42.3 connecting the second and third cylindrical walls 42.1, 42.3. The first and third cylindrical walls 40.1, 42.3 are configured to fit one into the other. The transverse wall 42.3 has an outer diameter D42.3 greater than the outer diameter D42.2 of the third cylindrical wall 42.2. Thus, when the first and third cylindrical walls 40.1, 42.3 are fitted one into the other, the first cylindrical wall 40.1 is in contact with the transverse wall 42.3.

According to one arrangement, the air/particle separation device 20 comprises a seal 44 interposed between the first and third cylindrical walls 40.1, 42.3.

Of course, the invention is not limited to this embodiment for the container 22. According to embodiments, the container 22 comprises at least one cylindrical lateral wall 22.1 having a given inner diameter.

According to one arrangement visible in FIG. 3, the laden-air inlet 24 is positioned in the lateral wall 22.1, between the lower transverse wall 22.2 and the rotary filter 36. The treated-air outlet 26 is positioned in the lateral wall 22.1, between the upper transverse wall 22.3 and the rotary filter 36.

The rotary filter 36 is configured to pivot about an axis of pivoting A36 that is oriented in the axial direction and substantially coaxial with the cylindrical lateral wall 22.1 of the container 22. When the axial direction is vertical, the axis of pivoting A36 is substantially vertical. According to one embodiment, the air/particle separation device 20 comprises a pivot shaft 46 having an axis coincident with the axis of pivoting A36, a pivoting connection 48 connecting the pivot shaft 46 and the container 22, and a drive 50 secured to the container 22 and having an output shaft connected to the pivot shaft 46. According to one configuration visible in FIG. 3, the pivoting connection 48 comprises two bearings 48.1, 48.2 positioned on either side of the rotary filter 36, in two substantially horizontal planes. According to one arrangement, the first bearing 48.1 is interposed between the second cylindrical wall 42.1 and the pivot shaft 46. In addition, the second bearing 48.2 is interposed between the lower transverse wall 22.2 and the pivot shaft 46.

According to one embodiment, the drive 50 is situated outside the container 22 and connected to the upper transverse wall 22.3.

The pivot shaft 46 extends from the first lower transverse wall 22.2 to the second upper transverse wall 22.3.

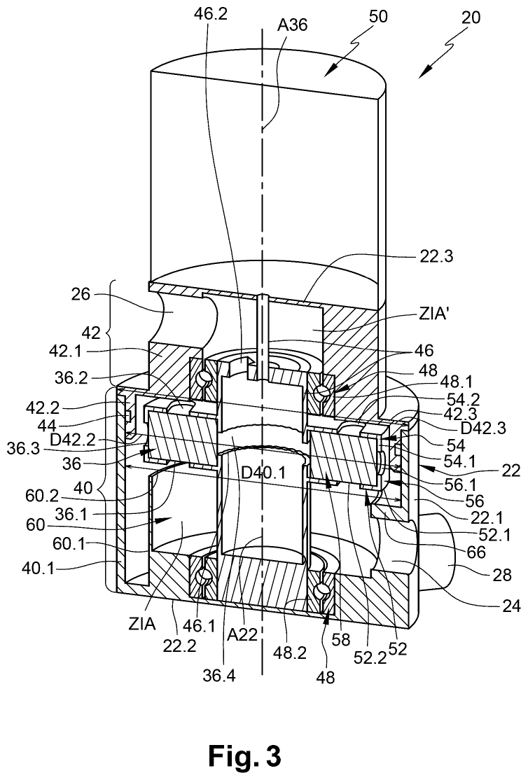

Of course, the invention is not limited to these embodiments for the pivot shaft 46, the pivoting connection 48 and the drive 50. According to a simplified variant visible in FIG. 2, the air/particle separation device 20 comprises a drive 50 secured to the container 22, and a pivot shaft 46 connected to the drive 50, the rotary filter 36 being positioned around the pivot shaft 46 and connected thereto.

According to one mode of operation, the rotary filter 36 is configured to pivot at a rotation speed greater than 8000 rpm.

According to one embodiment, the rotary filter 36 has an upstream face 36.1 substantially perpendicular to the axis of pivoting A36 and oriented toward the laden-air inlet 24, a downstream face 36.2 substantially perpendicular to the axis of pivoting A36 and oriented toward the treated-air outlet 26, and a peripheral face 36.3, connecting the upstream and downstream faces 36.1, 36.2, that is substantially coaxial with the axis of pivoting A36, said peripheral face being oriented toward the lateral wall 22.1 of the container 22 and having a smaller diameter than the inner diameter of the lateral wall 22.1. According to this embodiment, the laden air 30 enters the rotary filter 36 via its upstream face 36.1 and the particles are ejected from the rotary filter 36 by the centrifugal effect via the peripheral face 36.3.

According to one configuration, the rotary filter 36 comprises a cylindrical inner face 36.4 oriented toward the axis of pivoting A36.

According to one embodiment visible in FIG. 3, the rotary filter 36 has a ring shape with a constant square or rectangular section about the axis of pivoting A36. The cylindrical inner face 36.4 has an inner diameter substantially equal to the outer diameter of the pivot shaft 46.

The rotary filter 36 is immobilized in translation in the axial direction with respect to the pivot shaft 46. According to one embodiment, the air/particle separation device 20 comprises an upstream transverse wall 52 connected to the pivot shaft 46 and a downstream transverse wall 54 connected to the pivot shaft 46 and separated from the upstream transverse wall 52 by a distance substantially equal to or slightly less than the distance separating the upstream and downstream faces 36.1, 36.2 of the rotary filter 36. In operation, the rotary filter 36 is positioned between the upstream and downstream transverse walls 52, 54 and immobilized between the latter. Each of these upstream and downstream transverse walls 52, 54 has a circular peripheral edge 52.1, 54.1 having a diameter substantially equal to or slightly greater than the diameter of the peripheral face 36.3 of the rotary filter 36. According to one configuration, the air/particle separation device 20 comprises a cylindrical peripheral wall 56 connecting the peripheral edges 52.1, 54.1 of the upstream and downstream transverse walls 52, 54 and having a diameter substantially equal to or slightly greater than the diameter of the peripheral face 36.3 of the rotary filter 36. Thus, the air/particle separation device 20 comprises an annular housing 58, secured to the pivot shaft 46, delimited by the upstream and downstream transverse walls 52, 54, the pivot shaft 46 and the cylindrical peripheral wall 56 and configured to house the rotary filter 36 and immobilize it with respect to the pivot shaft 46.

The upstream transverse wall 52 comprises at least one first opening 52.2, for allowing the laden air 30 to pass through it in order to enter the rotary filter 36, configured to make the laden-air inlet 24 and/or the upstream inner zone ZIA of the container 22 communicate with the interior of the annular housing 58. The number, the shapes, the arrangement and the dimensions of the first opening(s) 52.2 are determined to permit the greatest possible flow rate of air passing through the upstream transverse wall 52.

The cylindrical peripheral wall 56 comprises at least one second opening 56.1 for allowing the particles 32 to pass through it in order to be ejected from the rotary filter 36. The number, the shapes, the arrangement and the second dimensions of the second opening(s) 56.1 are determined to facilitate the ejection of the particles 32 from the rotary filter 36.

According to one configuration, the downstream transverse wall 54 comprises at least one third opening 54.2, for allowing the treated air 34 exiting the rotary filter 36 to pass through it, configured to make the interior of the annular housing 58 communicate with the treated-air outlet 26 and/or the downstream inner zone ZIA′ of the container 22. The number, the shapes, the arrangement and the dimensions of the third opening(s) 54.2 are determined to obtain the greatest possible flow rate of air passing through the downstream transverse wall 54.

According to one embodiment, the pivot shaft 46 is hollow and comprises at least one first passage orifice 46.1, which allows the treated air 34 exiting the rotary filter 36 to enter the interior of the pivot shaft 46, configured to make the interior of the annular housing 58 communicate with the interior of the pivot shaft 46. The number, the shapes, the arrangement and the dimensions of the first passage orifice(s) 46.1 are determined to obtain the greatest possible flow rate of air exiting the rotary filter 36 and entering the pivot shaft 46.

The pivot shaft 46 also comprises at least one second passage orifice 46.2, allowing the treated air 34 to exit the pivot shaft 46, configured to make the interior of the pivot shaft 46 communicate with the treated-air outlet 26 and/or the downstream inner zone ZIA′. The number, the shapes, the arrangement and the dimensions of the second passage orifice(s) 46.2 are determined to obtain the greatest possible flow rate of air exiting the pivot shaft 46.

The invention is not limited to the embodiment visible in FIG. 3. In the presence of a hollow pivot shaft 46, the latter comprises passage orifices 46.1, 46.2 configured to make the cylindrical inner face 36.4 of the rotary filter 36, the interior of the pivot shaft 46 and the treated-air outlet 26 communicate.

The air/particle separation device 20 is configured to make the treated air 34 exit the rotary filter 36 via at least one face from among the downstream face 36.2 and the cylindrical inner face 36.4. According to variants, the treated air 34 exits solely from the downstream face 36.2, solely from the cylindrical inner face 36.4 or from the downstream face 36.2 and from the cylindrical inner face 36.4, as illustrated in FIG. 3.

According to one embodiment, the air/particle separation device 20 comprises an inner partition 60 positioned in the container 22 and configured to channel the laden air 30 in the direction of the rotary filter 36 and more particularly its upstream face 36.1. This inner partition 60 is positioned in the upstream inner zone ZIA. It is substantially cylindrical, coaxial with the lateral wall 22.1, spaced apart from said lateral wall 22.1 and extends between a first end 60.1 connected to the container 22, more particularly to the lower transverse wall 22.2, and a second end 60.2 slightly spaced apart from the rotary filter 36, more particularly from its upstream face 36.1. In the presence of an upstream transverse wall 52, the second end 60.2 of the inner partition 60 is slightly spaced apart from the upstream transverse wall 52. Slightly spaced apart is understood to mean that the distance separating the second end 60.2 of the inner partition 60 and the upstream transverse wall 52 or the upstream face 36.1 is of the order of a few millimeters, less than 10 mm and preferably less than 5 mm.

According to one arrangement, the inner partition 60 has a diameter that is smaller than or equal to the diameter of the peripheral face 36.3 of the rotary filter 36 or of the cylindrical peripheral wall 56 of the annular housing 58.

The inner partition 60 separates the upstream inner zone ZIA into a central zone 62 configured to channel the laden air 30 in the direction of the rotary filter 36 and a peripheral zone 64, situated between the inner partition 60 and the lateral wall 22.1, configured to collect the particles 32, the laden-air inlet 24 communicating with the central zone 62, the particle outlet 28 communicating with the peripheral zone 64. According to one arrangement, the particle outlet 28 opens out in a lower part of the peripheral zone 64 in order to enable exiting by gravity from the parts of the container 22.

According to one configuration, the inner partition 60 is spaced apart from the lateral wall 22.1 by a distance of between 5 and 20 mm.

In the presence of an inner partition 60, the air/particle separation device 20 may comprise at least one pipe 66 configured to make the laden-air inlet 24 and the central zone 62 communicate.

The operating principle of the air/particle separation device 20 is as follows.

The air/particle separation device 20 is positioned on a pipe in which a flow of air forced from upstream to downstream flows. Thus, the laden air 30 enters the air/particle separation device 20 via the laden-air inlet 24 and exits said device via the treated-air outlet 26.

The laden air 30 entering the air/particle separation device 20 then passes through the rotary filter 36, entering through its upstream face 36.1 and exiting via the downstream face 36.2 and/or the cylindrical inner face 36.4. In the rotary filter 36, the particles 32 are extracted from the laden air 30 which exits the rotary filter 36 in the treated state. The rotation of the rotary filter 36 promotes the separation of the particles 32 from the laden air 30 and the extraction of the particles 32 from the rotary filter 36 which migrate, by virtue of the centrifugal effect, toward the periphery of the rotary filter 36. This solution makes it possible to treat a greater flow rate of laden air than the air/particle separation devices of the cyclone type in the prior art.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An air/particle separation device comprising:
a container, a laden-air inlet, a treated-air outlet, a particle outlet opening out into the container, and a rotary filter positioned in the container, between the laden-air inlet and the treated-air outlet, the container being configured to channel air laden with particles through the rotary filter, said rotary filter comprising at least one block of cellular material configured to be passed through by a laden air,
an inner partition, positioned in the container, separating an upstream inner zone situated in the container, between the laden-air inlet and the rotary filter, into a central zone configured to channel the laden air in a direction of the rotary filter and a peripheral zone, situated between the inner partition and a lateral wall, configured to collect the particles, the laden-air inlet communicating with the central zone, and the particle outlet communicating with the peripheral zone.

2. The air/particle separation device as claimed in claim 1, wherein the container comprises at least one cylindrical lateral wall having an axis of revolution oriented in an axial direction, the axial direction being vertical, the rotary filter being configured to pivot about an axis of pivoting that is coaxial with the at least one cylindrical lateral wall of the container.

3. The air/particle separation device as claimed in claim 2, wherein the rotary filter comprises an upstream face oriented toward the laden-air inlet, a downstream face oriented toward the treated-air outlet, and a peripheral face, connecting the upstream and downstream faces, that is substantially coaxial with the axis of pivoting, said peripheral face being oriented toward the lateral wall of the container and having a smaller diameter than an inner diameter of the lateral wall.

4. The air/particle separation device as claimed in claim 3, wherein the rotary filter comprises a cylindrical inner face oriented toward the axis of pivoting, and wherein the air/particle separation device comprises a drive and a pivot shaft having an axis coincident with the axis of pivoting and connected to the drive, the rotary filter being positioned around the pivot shaft and connected thereto.

5. The air/particle separation device as claimed in claim 4, wherein the cylindrical inner face has an inner diameter substantially equal to an outer diameter of the pivot shaft.

6. The air/particle separation device as claimed in claim 4, wherein the pivot shaft is hollow and comprises passage orifices configured to make the cylindrical inner face of the rotary filter, an interior of the pivot shaft, and the treated-air outlet communicate.

7. The air/particle separation device as claimed in claim 4, wherein the air/particle separation device comprises an upstream transverse wall connected to the pivot shaft and a downstream transverse wall connected to the pivot shaft and separated from the upstream transverse wall by a distance substantially equal to or slightly less than a distance separating the upstream and downstream faces of the rotary filter.

8. The air/particle separation device as claimed in claim 7, wherein each of the upstream and downstream transverse walls comprises a circular peripheral edge, having a diameter substantially equal to or slightly greater than a diameter of the peripheral face of the rotary filter, and at least one opening passing through the respective circular peripheral edge.

9. The air/particle separation device as claimed in claim 8, wherein the air/particle separation device comprises a cylindrical peripheral wall connecting the peripheral edges of the upstream and downstream transverse walls and having a diameter substantially equal to or slightly greater than the diameter of the peripheral face of the rotary filter, the cylindrical peripheral wall comprising at least one opening passing through the cylindrical peripheral wall, the pivot shaft, the upstream and downstream transverse walls and the cylindrical peripheral wall delimiting an annular housing secured to the pivot shaft and configured to house the rotary filter.

10. The air/particle separation device as claimed in claim 1, wherein the particle outlet opens out in a lower part of the peripheral zone.

11. The air/particle separation device as claimed in claim 1, wherein the container comprises at least one cylindrical lateral wall, and wherein the partition is substantially cylindrical, coaxial with the lateral wall and extends between a first end connected to the container and a second end spaced apart from the rotary filter.

12. The air/particle separation device as claimed in claim 1, wherein the container comprises a lower part and un upper part, the lower part comprising a portion of the lateral wall and a lower transverse wall, the upper part comprising a portion of the lateral wall and an upper transverse wall, the lower and upper parts being configured to cooperate in order to form a closed enclosure when the lower and upper parts are assembled.

13. An installation comprising:
at least one item of equipment emitting a flow of laden air,
at least one pipe in which the flow of laden air exiting the at least one item of equipment circulates, and
the air/particle separation device as claimed in claim 1, positioned between two portions of the at least one pipe.
